(19) United States
(12) Patent Application Publication
(10) Pub. No.: US 2010/0131745 A1
(43) Pub. Date: May 27, 2010

(54) EXCEPTIONAL EVENTS

(75) Inventors: Henricus Johannes Maria Meijer, Mercer Island, WA (US); John Wesley Dyer, Monroe, WA (US); Jeffrey Van Gogh, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/277,887

(22) Filed: Nov. 25, 2008

(51) Int. Cl. G06F 9/44; G06F 9/00

(52) U.S. Cl. 712/244; 712/220; 712/E09.003

(57) ABSTRACT

An event-driven system enables handlers to be specified for success and failure, among other things. In other words, events can be explicitly encoded with an option of returning either a success or a failure result. In this manner, asynchronous programming and events can be unified. Multiple event streams can be employed to represent success and/or exceptional values. Alternatively, a disjoint union of regular and exceptional values can be employed with respect to a single event stream.

### CROSS-REFERENCE TO RELATED APPLICATIONS

This application is related to U.S. patent application Ser. No. ______ [Atty. Ref.: MS325084.01/MSFTP2422US, Meijer, et al.], entitled UNIFIED EVENT PROGRAMMING AND QUERIES, filed Nov. 25, 2008, U.S. patent application Ser. No. ______ [Atty. Ref.: MS325086.01/MSFTP2424US, Dyer, et al.], entitled EXPOSING ASYNCHRONOUS MECHANISMS AS FIRST-CLASS EVENTS, and U.S. patent application Ser. No. ______ [Atty. Ref.: MS325085.01/MSFTP2448US, Meijer, et al.], entitled LAZY AND STATELESS EVENTS, all of even date. The entireties of these applications are incorporated herein by reference.

### BACKGROUND

Event-based systems comprise a plurality of independent program parts or components that communicate by way of notifications. Events generally correspond to notable conditions that cause a change of state such as sensor output, user action, or component message. Event-based programs and/or portion thereof begin, wait for events, perform some action, and continue until explicitly terminated. By contrast, batch programs begin, perform an action, and stop.

Event-based programs are implemented with two main components event detection and event handling. Upon detecting occurrence of an event, a signal or notification is emitted. One or more event handlers respond to this notification by performing an action specific to the event. For example, upon detection of a button click, an event, some functionality is performed related to the click. In other words, a sender can detect an event and transmit a notification to a listening receiver, which can perform some designated action. Further, notifications sent by one component can trigger events in others resulting in a stream of events and notifications.

Most all programs, including event-based programs, are subject to errors or abnormal conditions. Such conditions also called exceptions (e.g., divide by zero, null pointer reference, out of memory . . . ) correspond to special events that trigger invocation of an exception handler. Exceptions are handled by dedicated systems so as to segment normal from abnormal operation. Conventionally, try-catch blocks are employed around a group of statements that might produce or throw an exception. As the name suggests, a try-catch block includes two portions—a “try” portion, which is able to throw an exception, and a “catch” portion that catches the thrown exception. The “catch” portion can even throw another exception.

Asynchronous programming is conventionally distinct from event-based programming. Synchronous programming calls for a single execution path. By contrast, asynchronous programming employs multiple execution paths and concurrent operation. More specifically, a caller on a first thread can invoke a callee on a second thread that executes some functionality and returns a result to the caller. Moreover, asynchronous operations do not wait or block for a response from before continuing execution as is done with synchronous operations. Rather, the caller continues operation and is able to accept the result from the callee at anytime. Consequently, asynchronous programming is often employed with respect to time intensive tasks such as connecting to a remote computer and querying a database, among other things.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains event processing in the presence of a variety of event categories including success and failure, amongst others. Rather than treating normal results and exceptional results as disparate, they can be unified as different kinds or categories of events. Consequently, handlers can be registered on normal events as well as exceptional events. Furthermore, exceptions that occur with respect to event generation and/or processing can be propagated to appropriate failure handlers.

In accordance with one aspect of the disclosure, producers can generate events of specific categories. Consumers can then acquire these events and invoke specific action as a function of the event category. For example, a handler can invoke a success continuation or callback for a normal event and a failure continuation for an exceptional event.

According to another disclosed aspect, events of various types can be represented in different manners. Events of any type can be first class objects or the like, thereby enabling them to be easily passed around and transformed, among other things. These events can then be pushed to either different events streams for particular categories such as success and failure or a single event stream comprising a disjoint union of successes and failures. Various transformation or operations can then be performed with respect to a stream representation.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an event-based system in accordance with an aspect of the disclosure.

FIG. 2 is a block diagram of the relationship between event categories and handlers in accordance with an aspect of the disclosure.

FIG. 3 illustrated different ways to represent success and failure in event streams in accordance with a disclosed aspect.

FIG. 4 is a block diagram of an event construction system in accordance with an aspect of the disclosure.

FIG. 5 is a block diagram of an event transformation system according to a disclosed aspect.

FIGS. 6a-b are block diagrams of a wrap and unwrap transformations in accordance with an aspect of the disclosed subject matter.

FIG. 7a illustrates a swap component in accordance with an aspect of the disclosure.

FIG. 7b depicts a catch component in accordance with an aspect of the disclosed subject matter.

FIG. 8 is a block diagram of an event processing system in accordance with an aspect of the disclosure.

FIG. 9 is a flow chart diagram of a method of event processing in accordance with a disclosed aspect.

FIG. 10 is a flow chart diagram of an event handling method in accordance with an aspect of the disclosure.

FIG. 11 is a flow chart diagram of an event processing method according to an aspect of the disclosed subject matter.

FIG. 12 is a flow chart diagram of method of event stream processing according to a disclosed aspect.

FIG. 13 is a flow chart diagram of an events stream processing method in accordance with an aspect of the disclosure.

FIG. 14 is a block diagram of a system within which aspects of the disclosure can be employed.

FIG. 15 is a schematic block diagram illustrating a suitable operating environment for aspects of the subject disclosure.

FIG. 16 is a schematic block diagram of a sample-computing environment.

### DETAILED DESCRIPTION

Systems and methods pertaining to exceptional events are described in detail hereinafter. Events can correspond to two or more different categories or sub-types including success and failure, among others. In this manner, handlers can be defined with respect to these types of events. Different implementations are disclosed including a single event stream that can include either normal or exceptional values or multiple streams designated specifically for normal results and exceptional results. Various transformations can also be employed with respect to particular events to facilitate processing among other things.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

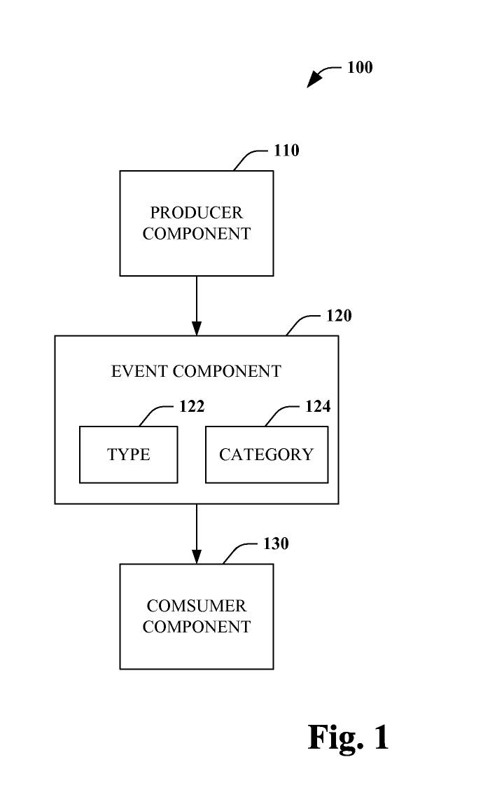

Referring initially to FIG. 1, an event-based system 100 is illustrated in accordance with an aspect of the claimed subject matter. As shown, the system 100 includes a producer component 110, an event component 120, and a consumer component 130. The producer component 110 produces or otherwise generates or triggers an event 120 that can be consumed or otherwise processed by the consumer component 130. Event processing is based on a push model where the producer component 110 is in control, pushing event components 120 or values to the consumer in an asynchronous fashion. By contrast, in a pull model the consumer component 110 would be in control asking the producer to deliver each value in sequence in synchronous manner.

In accordance with one embodiment the producer component 110 can correspond to an event source while the consumer is an event handler. Here, the handler specifies a particular action associated with the occurrence of an event. Similarly, asynchronous code can be combined with event processing. In particular, an event handler can be specified in a continuation monad style such that a handler is invoked when the asynchronous computation finished. Furthermore, the consumer component 120 and the producer component 110 can correspond to a caller and callee, respectively, in an asynchronous computing model, where the producer affords a normal or exceptional result to the consumer component 120.

Similar to conventional events, the event component 120 can correspond to notable condition that changes state such as that caused by user action (e.g., mouse click), among other things. In other words, an event is a message that indicates that something has happened. In addition to simple source events, it is also to be noted that events can be more complex composite or compositional events. Composite events are derived from or somehow related to one or more other events. For instance, composite events can be combinations of two or more events or causally related such that the occurrence of a first event causes a second event.

Furthermore and in accordance with an aspect of the claimed subject matter, the event 120 can be a first class program language construct or structure. Conventionally, events are tightly coupled to classes, for example, much like class properties. However, events can be produced that behave as other first class program constructs such as integers. In other words, events can be created and passed around, among other things.

The event component 120 can also include or be of a specific type 122 and/or category 124. For example, the actual value that embodies an event can be of a particular data type (e.g., string, integer, Boolean . . . ). Moreover, this value can be of a specific type or category. In accordance with an aspect of the claimed subject matter, the event category can signify success, or failure, amongst others. In other words, the event component 120 can correspond to a normal result (normal event) or an exceptional result (exceptional event) thereby unifying the two, which is very useful. In particular, this allows handlers to be specified for specific types of events.

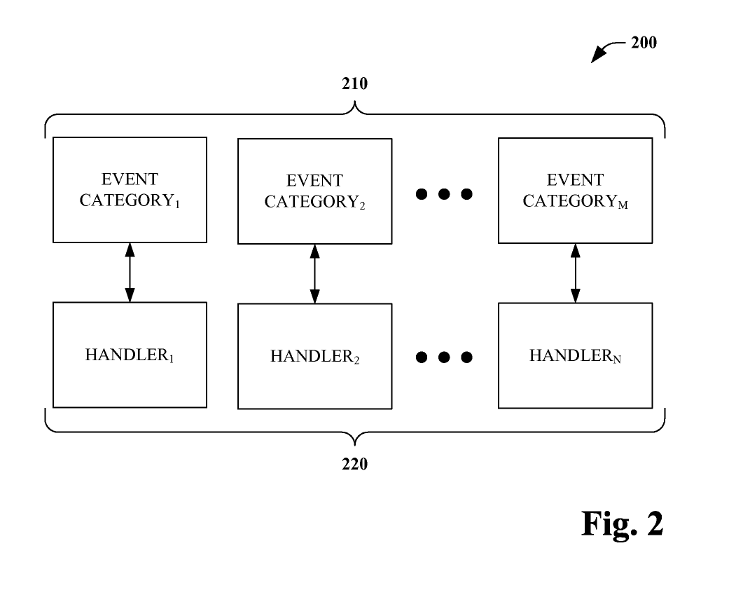

Turning attention to FIG. 2, the relation between event categories and handlers is graphically depicted. As shown, there can exist a plurality of event categories 210 (EVENT CATEGORY₁−EVENT CATEGORYE_{M}, where M is an integer greater than or equal to one) and handlers 220 (HANDLER₁−HANDLER_{N}, where N is an integer greater than or equal to one) that can be afforded for each event category. As mentioned, two event categories 210 can be success and failure, which can include corresponding handlers 220.

However, various scenarios can exist that utilize more than two event categories 210 or a different set of categories 210. By way of example and not limitation, consider a weather service that can return results in Centigrade or Fahrenheit. Now, a first handler 220 can be called if the service terminates successfully and returns results in Centigrade, a second handler 220 can be invoked if successful termination returns Fahrenheit results, and a third handler 220 can called if an exception occurs, such as when no temperature reading is available. Another scenario can involve fuzzy values that can be supported and implemented in terms of one or more handlers 220. For instance, multiple handlers 220 can be invoked to capture known, unknown, and degrees of potentially known/unknown values. Many other scenarios are possible and contemplated.

As previously mentioned briefly above, handlers 220 can employ continuation monads. In other words, handlers can be specified in continuation passing style to effect asynchronous processing. As will be described in further detail infra, handlers 220 can employ continuations with respect to various event categories. For example, continuations can be specified for both success and failure.

It is to be appreciated that the remainder of the detailed description with focus on success and failure categories to facilitate clarity and understanding with respect to other aspects, rather than convoluting the description with respect to a plurality of event categories. Of course, the claimed subject matter is not limited thereto. Aspects described below can easily be extended to more than two different types of event categories.

Dealing with exceptions in event processing and asynchronous code is difficult in contemporary programming languages. In fact, conventional event-based frameworks only call back on successful events, but do not allow consumers to be notified of failures. Moreover, because callbacks are invoked asynchronously, in general they are far removed in time and space from handler functionality. This means that in addition to difficulty associated with exceptions in event processing and asynchronous programming it is hard to deal with exceptions in the handler itself.

By way of example, consider the following code snippet:

```
try {
  button.Click += delegate{ ...x/y...};
} catch (DivisionByZeroException e){
  ...
}
```

Here, the try/catch block does not guard against the potential division by zero error in the handler. By the time the handler is invoked asynchronously by the button (e.g., producer of the event), control will have moved beyond the try-catch block. Moving the exceptions handling inside the handler is not always an option because even then it happens in a different context.

Now consider the following example where an asynchronous computation starts to compute a call “F(a₀, . . . , aₙ₋₁)” that might throw an exception on a background thread and register a call back to receive the result of the call:

```
try {
  AsyncBackgroundWorker.OnDone += delegate(Result r){...};
  AsyncBackgroundWorker.Start (F, a₀,..., aₙ₋₁)
} catch (Exception e){
  ...
}
```

Again, wrapping the code inside a try/catch will not protect from errors that occur while executing the function in the background thread.

In accordance with yet another example, consider the following code sample:

Button b = new Button( );
b.Click += (o, e)=> {if((Sum(Transactions)/Transactions.Count) >
1000) RequestExtraVerificationOnHightAmounts( ); }
b.Click += (o,e) => {DeductMoneyFromAccount( );}

In this mockup application, two separate actions are triggered when a user clicks on a button. If the list of transactions is currently empty (Transactions.Count=0), the first action listed will throw a “DivisionbyZeroException.” In accordance with convention, there is no way to control exceptions with events, other than writing a try/catch in each separate handler. Further, conventional frameworks gives very little if any control over exceptions, and as the order of actions being called is not guaranteed, there is no guarantee the second action listed is even called. In other words, it is undefined what happens to the rest of the code in this scenario.

Exceptions can occur in transformation functions and source events as well as event handlers. Transformation functions can transform a first event or event stream to a second event or event stream. Such transformation often occurs with respect to composite or compositional events, for example mapping an event stream to a new event stream or filtering an event stream based on some criteria. Suppose an event stream is being filtered. An event stream can be taken as a source and a predicate provided which is a function of from values that are carried on the event to Boolean values of whether or not they should be output on the final stream. In the process of computing the result of a predicate, that function could throw an exception. In accordance with one aspect, this can actually be a special case of the handler scenario, because events can be composed by adding handlers. However, it looks different to users so it is worth calling out.

As per source events, something causes events to be raised within an event stream. Since it is allowed that successful events happen, to be complete it should also be noted that failures could happen at the source. Accordingly, outside things can reach in and indicate that a failure has occurred and it should be added to an event stream workflow. Now, the outside world can communicate failure into event workflows.

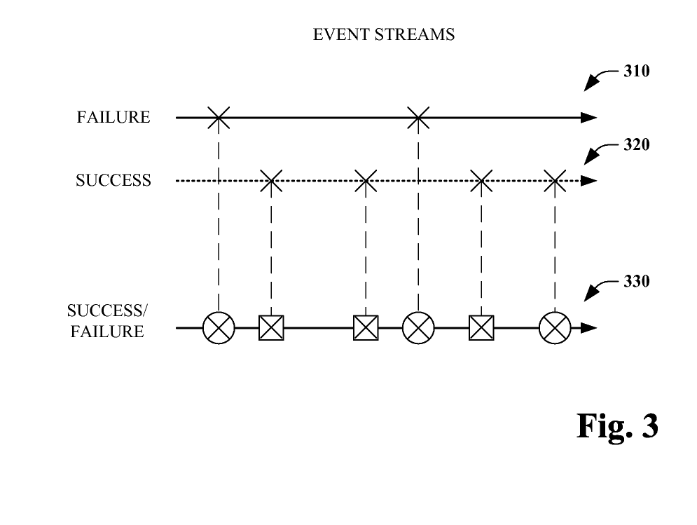

In accordance with an aspect of the claimed subject matter, events can encode the option of signaling either success or failure. In furtherance thereof, there are at least two ways of representing both success and failure, depicted in FIG. 3. In one implementation, two events streams can be utilized: one stream 310 for successes as is conventionally done and a second stream 320 for failures. Alternatively, a single event stream 330 can be utilized that includes either successes or failures. In this case, events can include metadata such as a flag or the like that indicates whether an event is a success or failure. In other words, the single event stream 330 can be a discriminated union of successes and failures. Furthermore, it is to be appreciated that an event can also include explicit knowledge about what action to a call on either success or failure (e.g., continuation/callback). It should be noted that employing two event streams is equivalent to employing a single events stream with either successes or failures. However, in some instances one representation may be better than another.

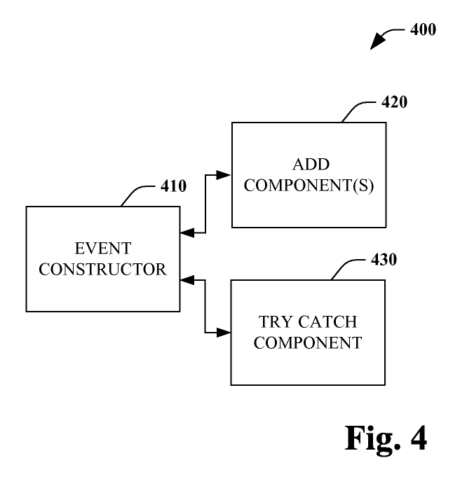

Turning attention to FIG. 4, an event construction system 400 is illustrated in accordance with an aspect of the claimed subject matter. The system 400 includes an event constructor component 410 that constructs a first class event. Furthermore, handlers can be added to the constructed event by way of either add component 420 or try catch component 430. The add component 420 enables handlers to be added that include callbacks for success and/or failure. Therefore, if an event is of type success the success callback is invoked. Otherwise, the failure callback is called to handle an exceptional event. The try catch component 430 allows handlers to be added that function in accordance with a try catch pattern. As with the add component(s) 420, if event is of type success, its success continuation is called while the failure continuation is called for an exceptional event. However, if the success continuation fails or generates an exception, the failure continuation is also invoked. In other words, it functions as if the success continuation is included in the try block of a try catch construct. By way of example and not limitation, a constructed event can implement the following generic interface:

```
interface IEvent<T>
{
    Action Add(Action<T> succeeded)
    Action Add(Action<T> succeeded, Action<Exception> failed)
    Action TryCatch(Action<T> succeeded, Action<Exception> failed)}
}
```

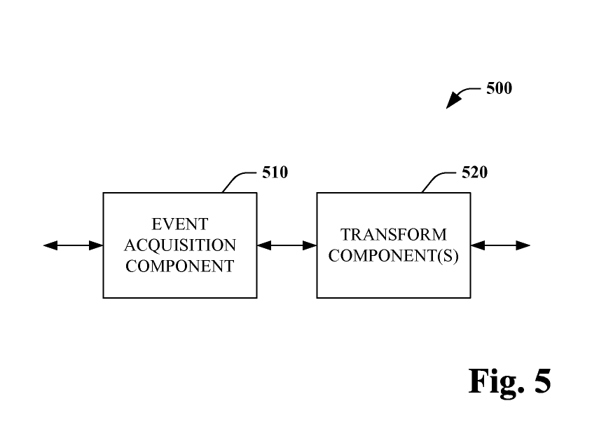

FIG. 5 depicts an event transformation system 500 in accordance with an aspect of the claimed subject matter. The system includes an event acquisition component 510 that receives, retrieves, or otherwise obtains or acquires an event or event stream. The transformation component(s) 520 perform some action or transformation with respect to the acquired event or event stream. In accordance with one aspect of the claimed subject matter, the transform component(s) 520 can correspond to query operators for events or combinators.

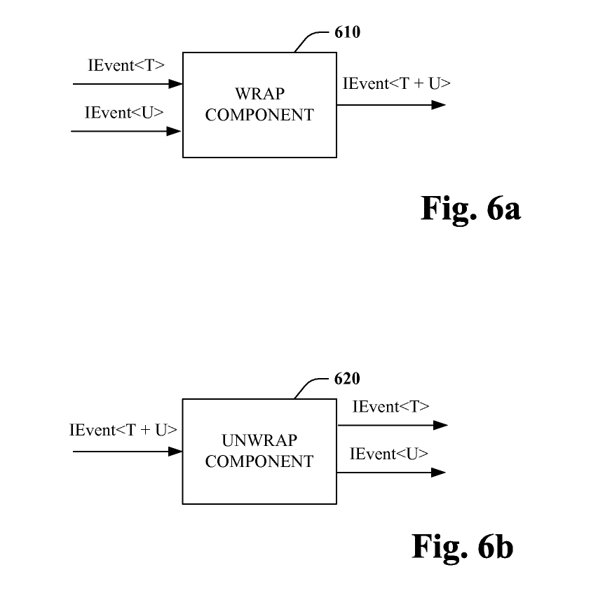

Referring to FIGS. 6a-b, two possible transformation components or operators 520 are illustrated in accordance with an aspect of the claimed subject matter. As previously mentioned, event streams can be represented as either a pair of event streams for success and failures or a single event stream that can include both successes and failures. In various scenarios, a particular implementation may be required or desired, thus necessitating conversion from one implementation to another. FIG. 6a illustrates a wrap component 610 that receives as input a union of regular values “IEvent<T>” and exceptions “IEvent<U>” and produces a single event stream including both success and failures “IEvent<T+U>.” Conversely, FIG. 6b depicts an unwrap component 620 that receives a single event stream of either successes or failures “IEvent<T+U>” and returns two streams “IEvent<T>” and “IEvent<U>.” Two exemplary method signatures associated with the above are:

public IEvent<_> Wrap<_>( this IEvent<Either<Exception,_>> source)
public static IEvent<Either<Exception,_>> Unwrap<_>(this IEvent<_>
source)

The implementation of the above conversions rely on the fact that both the type constructors “IEvent<_>” and “Either<Exception,_>” are monads, and that the composition “IEvent<Either<Exception,_>>” can be defined by lifting operations over the underlying monad (the resulting form of events may not fire on the failure continuation). This also works the other way around. It is possible to internally use “IEvent<Either<Exception,_>>” and unlift to “IEvent<_>.”

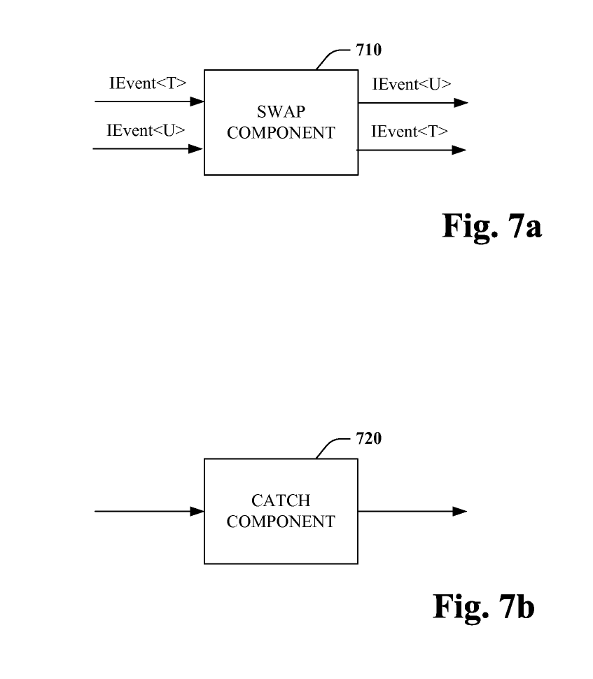

FIG. 7a illustrates another exemplary transformation or operator namely swap component 710. In accordance with an aspect, some transformations or operators can work exclusively on a success branch of an event stream. If there is a failure, it will just pass through, and if there is a new failure, it will be moved to the failure branch. Further, a user may not be able to add code to deal with a failure branch. Since these flow paths through the events are really just the same thing, the swap component 710 can be employed to enable swapping. For example, if there is an “IEvent” of either “T” or “U,” this allows swapping the “T” and “U.” Now operators effective only on success branches can be employed on failure branches or vice versa.

FIG. 7b depicts yet another transformation, query operator or combinator—catch component 720. The catch component 720 provides various mechanisms for catching exceptions and performing some action. Consider the following method signatures:

IEvent<T> Catch<T>(IEvent<T> e, Func<Exception, IEvent<T>>
handler)
IEvent<T> Catch<T>(IEvent<T> e, Action handler)
IEvent<T> CatchSelect<T>(IEvent<T> e, Func<Exception, T> handler)

The first catch operator catches an exception of failure and replaces the faulty computation. The second operator catches an exception, executes a sided effect and stops. Finally, the third “CatchSelect” operator catches an exception and changes a failure into a success.

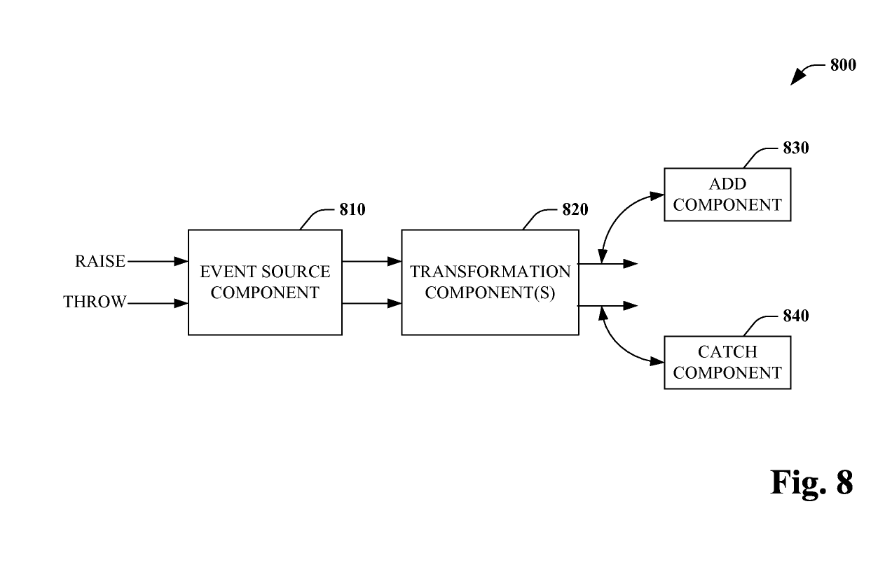

FIG. 8 illustrates an event processing system 800 in accordance with an aspect of the claimed subject matter. Event source component 810 fires or triggers events of a particular category, namely success or failure. In other words, an event is raised or an exception is thrown, among other things. Subsequently, various operations are performed with respect to streams of events and/or exceptions by way of one or more transformation components 820. For example, various combinators can be employed to produce composite events. Add component 830 provides a mechanism to afford handlers for dealing with raised events (successes, normal values). Additionally, catch component 840 provisions actions for processing exceptional events. For instance, the catch component can enable an exception to be caught and transformed into a success, which can be processed by a handler supplied by the add component 830. It is to be appreciated that the add component 830 and catch component 840 can operate with respect to events and/or exceptions generated throughout an event process or workflow. For example, while the event source can trigger events and/or exceptions, it could also fail and generate an exception. Similarly, one or more transformations can fail and throw an exception.

Returning briefly to FIG. 5, in accordance with an aspect of the claimed subject matter, the disclosed event processing system 500 can acquire or catch all generated events via event acquisition component 510. However, if there is a memory exception or other serious exceptions the application should be allowed to crash since nothing logical can be performed. To allow should behavior, a transformation component 520 can filter out exceptions to enable them to bring down an application. Alternatively, the event should be re-thrown or a special event generated that has the same effect.

It should also be appreciated that conventionally exceptions invoke thoughts of an exception object, unwinding the stack, etc. However, where an event is thrown in the “IEvent” world none of that really needs to happen. Basically, control flow can be hijacked and these event flows can just can passed around like any other object. Accordingly, an exception is just another object that happens to be going on an exception branch.

Still further yet, aspect of the claimed subject matter can be employed for performance optimization. Conventionally machinery is optimized for the normal case where a normal value is returned. As a result, exceptions are very expensive. For example, every thrown of an exception can be propagated all the way to an operating system kernel and multiple stack walks can be required in an attempt to determine where the exception should be delivered, among other things. This is very inefficient. Here, however, there is really no difference between normal results and exceptional results. They are completely symmetrical. Essentially an exception is transformed into a special first class event. Accordingly, an exceptional result is as cheap as a normal result. For example, once a callee is finished, either exceptionally or normally, it can just call a handler what will deliver the result to the caller rather than using a runtime stack or the like for that mechanism. Furthermore, programs can be specified or refactored in a manner that makes use of exceptions to improve efficiency, among other things.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, event handlers can employ such mechanisms.

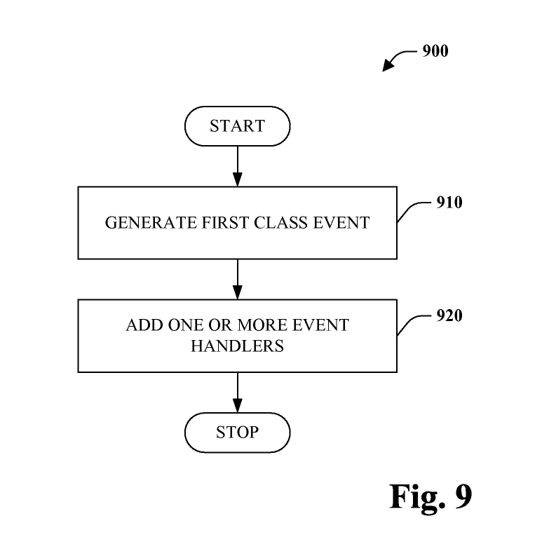

In view of the exemplary systems described supra, methodologies that may be implemented in accordance with the disclosed subject matter will be better appreciated with reference to the flow charts of FIGS. 9-13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a method of event processing 900 is illustrated in accordance with an aspect of the claimed subject matter. At reference numeral 910, a first class language event is generated. This enables an event to be passed around like other first class constructs such as integers, rather than being typed to a class, for instance. At numeral 920, one or more event handlers are added to the event. Furthermore, handlers can be specified for various event categories including success and failure, among others. In accordance with one embodiment, a handler can include continuations or callbacks for normal and exceptional results thereby unifying the two.

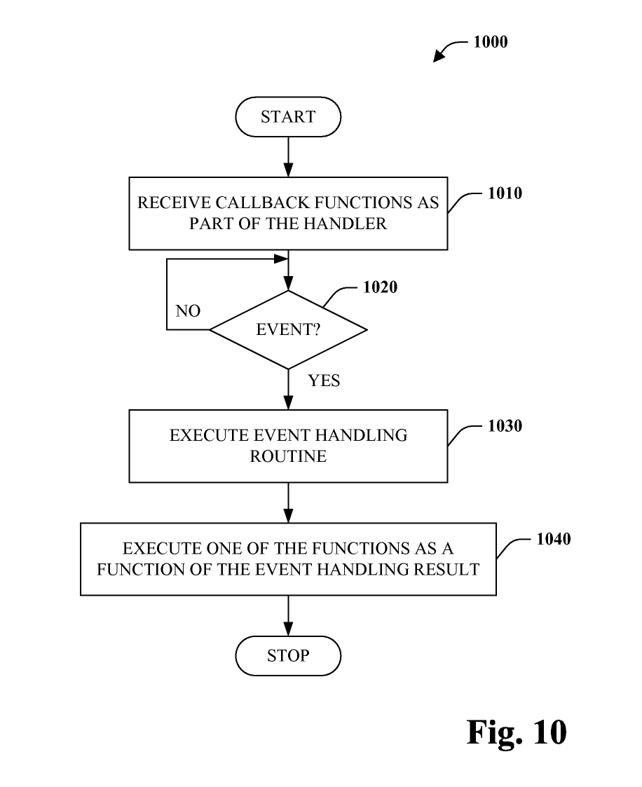

FIG. 10 is an event handling method 1000 in accordance with an aspect of the claimed subject matter. At reference numeral 1010, numerous callback functions are received as a part of a handler for an event. At numeral 1020, a check is made as to whether or not a particular event has occurred. If no, the method continues to loop until an event is triggered. If has, the method proceeds at 1030 where an event handling routine is executed. At reference numeral 1040, a continuation function is executed has function of the event handling result. For example, if the handler returns a normal value then a success callback function will be invoked, whereas if an exception occurs, then a failure callback function will be invoked. Similarly, if a normal result occurs and it is of a particular type or kind then a corresponding call back can be invoked.

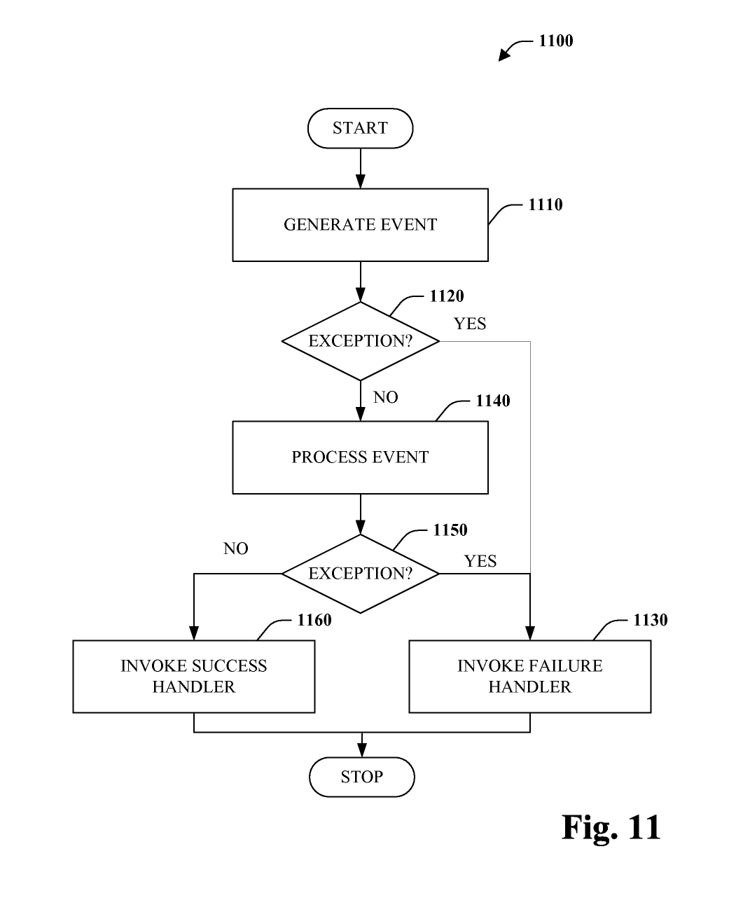

FIG. 11 is an event processing mechanism in accordance with an aspect of the claimed subject matter. At reference numeral 1110, an event is generated or raised, for example by an event source. A determination is made at 1120 as to whether or not an exception thrown with respect to event generation. If yes, a failure handler is invoked at 1130 for dealing with the exception. Alternatively, where an exception is not thrown at 1120, the method continues at 1140 where the event is processed. In particular, this can correspond to invoking functionality associated with an event handler or event composition, among other things. At numeral 1150, a determination is made concerning whether or not an exception was thrown during event processing. If yes, a failure handler or callback function associated with failure can be invoked. If no, a success handler or callback function related to success can be invoked. Accordingly, exceptions that occur during event generation and processing can be propagated to call failure handlers/continuations/callbacks.

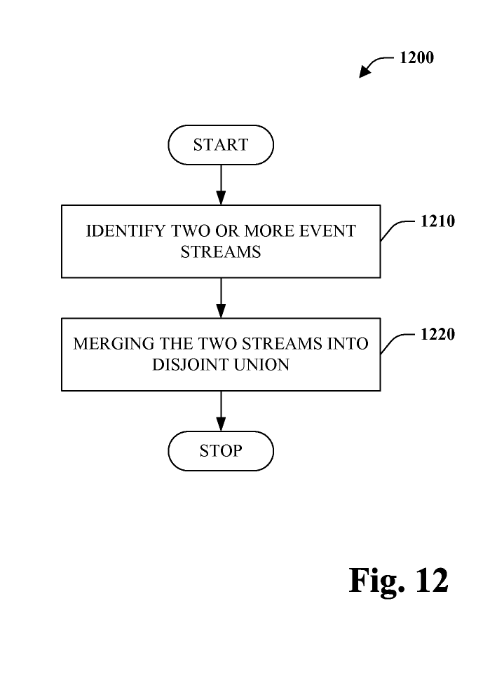

FIG. 12 is a flow chart diagram of a method of event stream processing 1200 in accordance with an aspect of the claimed subject matter. At reference numeral 1210, one two or more event streams are identified, for example one can be associated with successes and another with failures, among others. At reference numeral 1220, the two or more streams are merged or wrapped into a disjoint or discriminated union. In other words, a single event stream can include both successes and failures, for instance. By way of example, the event stream can include a plurality of events some of which are tagged or otherwise marked as exceptional.

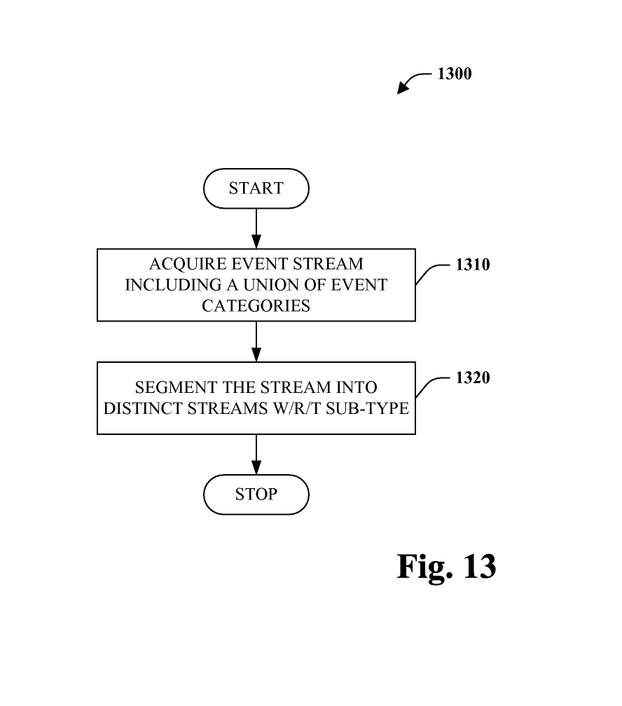

FIG. 13 is a method of events stream processing 1300 in accordance with an aspect of the claimed subject matter. At reference numeral 1310, an event stream including a disjoint union of event categories. For instance, the event stream can include numerous success and failure events, among others. At numeral 1320, the event steam is segmented into distinct event streams with respect to specific event categories. In the above example, success can be identified and placed into a dedicated success event stream, and failures can be located and added to a specific failure stream.

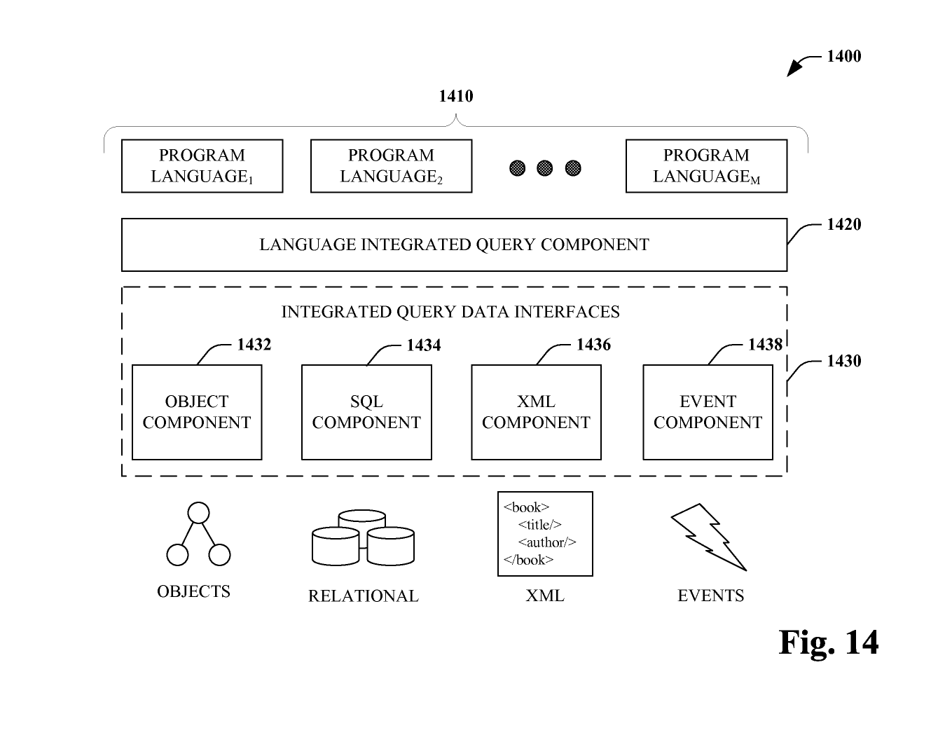

Turning attention to FIG. 14, an exemplary system 1400 is provided for which aspects of the claimed subject matter can be employed. In particular, the system 1400 can operate over a plurality of programming languages 1410 (PROGRAM LANGAUGE₁−PROGRAM LANGUAGE_{M}, where M is an integer greater than or equal to one). For example, such languages can include but are not limited to object oriented languages such as C#, Visual Basic, and Java. Further, the system 1400 includes a language integrated query component, facility or the like 1420. This component 1420 enables integration of declarative style queries, similar to those utilized with respect to SQL (Structured Query Language), to be integrated with a user's primary programming language 1410. Further, the component 1420 allows query expressions to benefit from compile-time syntax checking, static typing, and intelligent assistance, among other things previously only available to imperative code. Additionally, the system 1400 includes a plurality of integrated query data interfaces 1430. These interfaces 1430 allow queries over different types of data. As shown, object component 1432 enables queries over objects; SQL component 1434 allows structured query language queries over relational data; and XML component 1436 enables interaction with extensible markup language (XML) data. Moreover, event component 1438 enables language-integrated queries over events. It is here where aspects of the claimed subject matter can be incorporated. By way of example and not limitation, query operators can be performed to wrap and unwrap event streams as well as catch and process exceptions.

It should be appreciated that in this detailed description an implementation events with respect to “IEvent<T>” has been described. Of course, this is only one implementation, and others are also possible and contemplated. For example, rather than implementing an event as “IEvent<T>” it can be implemented as “Control<S>.Flow<T>.” Here, “Control<S>” is parameterized with a type of failure branch “S,” and “Flow<T>” is parameterized with a type of success branch “T,” By default, “IEvent<INT>” would be represented as “Control<Exception>.Flow<INT>.” However, the later is generally more complex and expressive representation over which various swapping and binding operations can be performed with respect to two paths. In “IEvent<T>” the type of failure can implicitly fixed as exception while the “<T>” can still be parameterized.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

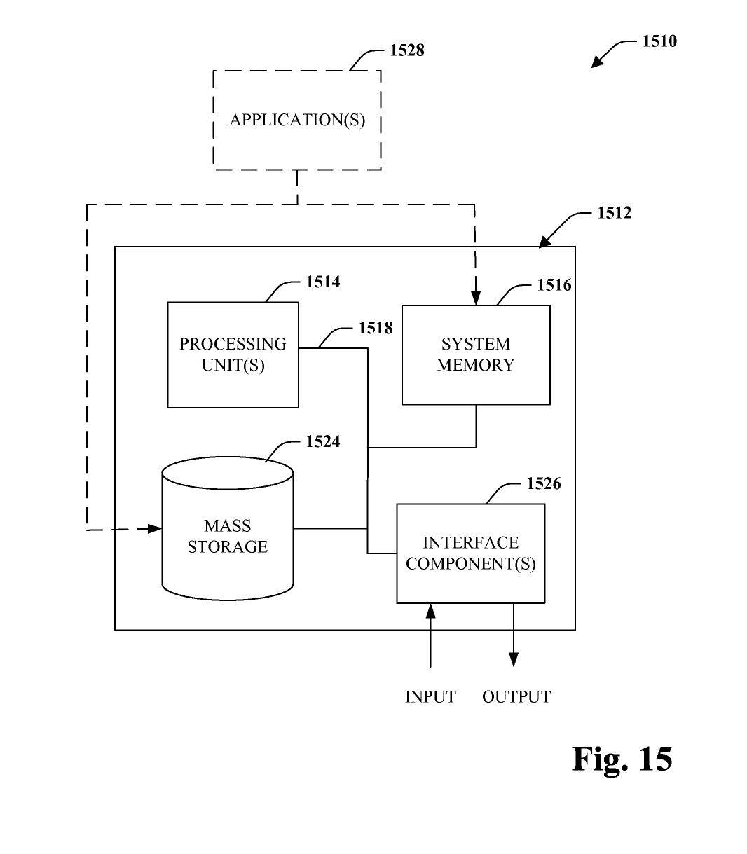

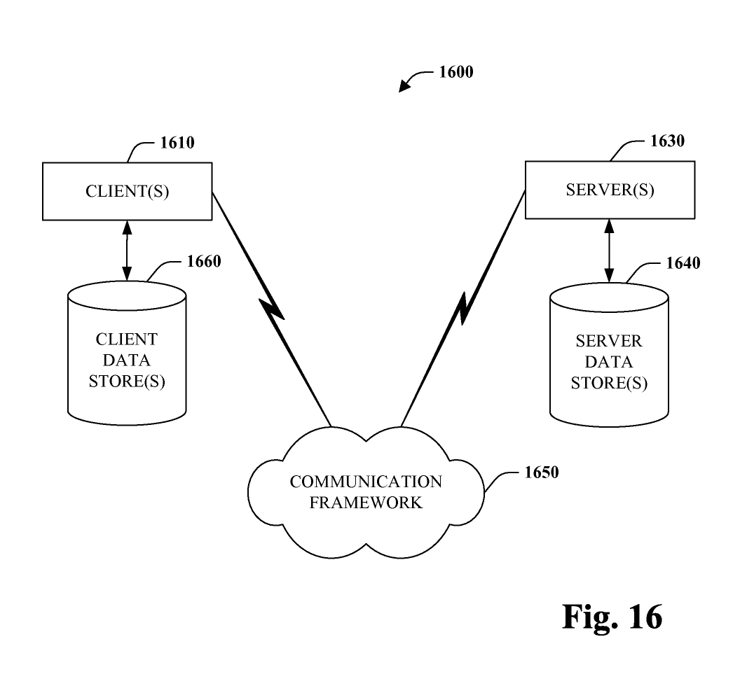

In order to provide a context for the various aspects of the disclosed subject matter, FIGS. 15 and 16 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 15, an exemplary environment 1510 for implementing various aspects disclosed herein includes a computer 1512 (e.g., desktop, laptop, server, hand held, programmable consumer or industrial electronics . . . ). The computer 1512 includes a processing unit 1514, a system memory 1516, and a system bus 1518. The system bus 1518 couples system components including, but not limited to, the system memory 1516 to the processing unit 1514. The processing unit 1514 can be any of various available microprocessors. It is to be appreciated that dual microprocessors, multi-core and other multiprocessor architectures can be employed as the processing unit 1514.

The system memory 1516 includes volatile and nonvolatile memory. The basic input/output system (BIOS), containing the basic routines to transfer information between elements within the computer 1512, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1512 also includes removable/non-removable, volatile/non-volatile computer storage media. FIG. 15 illustrates, for example, mass storage 1524. Mass storage 1524 includes, but is not limited to, devices like a magnetic or optical disk drive, floppy disk drive, flash memory, or memory stick. In addition, mass storage 1524 can include storage media separately or in combination with other storage media.

FIG. 15 provides software application(s) 1528 that act as an intermediary between users and/or other computers and the basic computer resources described in suitable operating environment 1510. Such software application(s) 1528 include one or both of system and application software. System software can include an operating system, which can be stored on mass storage 1524, that acts to control and allocate resources of the computer system 1512. Application software takes advantage of the management of resources by system software through program modules and data stored on either or both of system memory 1516 and mass storage 1524.

The computer 1512 also includes one or more interface components 1526 that are communicatively coupled to the bus 1518 and facilitate interaction with the computer 1512. By way of example, the interface component 1526 can be a port (e.g., serial, parallel, PCMCIA, USB, FireWire . . . ) or an interface card (e.g., sound, video, network . . . ) or the like. The interface component 1526 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 1512 to output device(s) via interface component 1526. Output devices can include displays (e.g., CRT, LCD, plasma . . . ), speakers, printers, and other computers, among other things.

FIG. 16 is a schematic block diagram of a sample-computing environment 1600 with which the subject innovation can interact. The system 1600 includes one or more client(s) 1610. The client(s) 1610 can be hardware and/or software (e.g., threads, processes, computing devices). The system 1600 also includes one or more server(s) 1630. Thus, system 1600 can correspond to a two-tier client server model or a multi-tier model (e.g., client, middle tier server, data server), amongst other models. The server(s) 1630 can also be hardware and/or software (e.g., threads, processes, computing devices). The servers 1630 can house threads to perform transformations by employing the aspects of the subject innovation, for example. One possible communication between a client 1610 and a server 1630 may be in the form of a data packet transmitted between two or more computer processes.

The system 1600 includes a communication framework 1650 that can be employed to facilitate communications between the client(s) 1610 and the server(s) 1630. The client(s) 1610 are operatively connected to one or more client data store(s) 1660 that can be employed to store information local to the client(s) 1610. Similarly, the server(s) 1630 are operatively connected to one or more server data store(s) 1640 that can be employed to store information local to the servers 1630.

Client/server interactions can be utilized with respect with respect to various aspects of the claimed subject matter. By way of example and not limitation, various components can be embodied as network or web service. Furthermore, processing can be split or distributed across multiple processors or machines. For instance, event handlers can be processed on one processor and callback to code on another processor.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. An event-driven system, comprising:
a producer component that generates a first-class program language event of a particular event category; and
a consumer component identifies the event and performs an action as a function of the event category.

2. The system of claim 1, the category is either success or failure indicative of a state of an action performed by the producer component.

3. The system of claim 2, the consumer is a callee, the producer is a caller, and the event is a callback that signals task completion in an asynchronous programming model.

4. The system of claim 2, the consumer is an event handler and the producer is an event source.

5. The system of claim 4, the event handler is continuation or callback function.

6. The system of claim 2, an event of category failure results upon occurrence of an exception in event generation or event handling.

7. The system of claim 1, events are represented on multiple event streams as a function of their category such that a single event stream is present for each category.

8. The system of claim 1, the events are represented on a single event stream as a disjoint union of different categories.

9. A computer-implemented method of event processing, comprising:
identifying an event in an event stream; and
performing an action as a function of a normal or exceptional result afforded by the event.

10. The method of claim 9, further comprising identifying an event from one of two events streams, one including normal results and the other including exceptional results.

11. The method of claim 9, further comprising transforming a multiple stream representation of normal and exceptional events into a single event stream.

12. The method of claim 9, further comprising transforming a single stream representation of normal and exceptional events into a multiple stream representation.

13. The method of claim 9, further comprising receiving functions that specify the action.

14. The method of claim 9, further comprising catching a failure in an action performed in response to a normal result and invoking the action associated with the exceptional result.

15. The method of claim 9, further comprising propagating exceptions thrown in conjunction with operators defined on events to the event stream as exceptional result events.

16. The method of claim 9, further comprising propagating exceptions thrown by event triggers to the event stream as exceptional result events.

17. A computer-implemented method of event handling, comprising:
generating a first-class event;
processing the event; and
propagating exceptions that occur during event generation and/or processing to user-specified failure handlers, the exceptions are represented as a type of event.

18. The method of claim 15, comprising catching and re-throwing an exception.

19. The method of claim 15, comprising catching and throwing a new exception.

20. The method of claim 15, comprising catching an exception and repairing a computation that resulted in throwing of the exception.
